(19) United States
(12) Patent Application Publication
(10) Pub. No.: US 2006/0263505 A1
(43) Pub. Date: Nov. 23, 2006

(54) Ingredient for grilled food item and method of preparation

(75) Inventor: Barbara K. Schmitt, Downers Grove, IL (US)

Correspondence Address: Bingham McCutchen LLP, Three Embarcadero Center, Suite 1800, San Francisco, CA, 94111-4067, US

(73) Assignee: ConAgra Foods Packaged Foods Company, Inc., Naperville, IL (US)

(21) Appl. No.: 11/490,773

(22) Filed: Jul. 21, 2006

Related U.S. Application Data
(62) Division of application No. 10/719,850, filed on Nov. 21, 2003.

(51) Int. Cl. A23L 1/05

(52) U.S. Cl. 426/573

(57) ABSTRACT

An ingredient for a microwaved food item, an ingredient and food item combination, and a method of preparing an ingredient. The ingredient includes a gelatinous base and one or more additives that are mixed with said gelatinous base to form a mixture. When heated in a microwave oven, the mixture releases steam with the one or more additives onto the food item to add flavorings, aromas and/or colorings to the food item.

### CROSS REFERENCE TO RELATED APPLICATION

The present invention is a divisional of co-pending U.S. application Ser. No. 10/719,850, filed Nov. 21, 2003, priority of which is claimed under 35 U.S.C. 120, and the contents of which are incorporated herein by reference.

### FIELD OF THE INVENTION

The present invention relates to ingredients for microwave food items, and more particularly, to a gelatinous ingredient for a grilled food item prepared in a microwave oven.

### DESCRIPTION OF RELATED ART

Various types of microwave food items have been produced using various heating devices and ingredients. For example, some conventional food items are placed between susceptor or cooking surfaces. Activating the microwave oven heats the cooking surfaces, and the food item is cooked there between. Apertures formed through a bottom cooking surface permit water, oil, fat or other liquids from the cooked food item to drain into the bottom of the package. Yet other conventional microwaved food products include a microwaveable tray divided into compartments. Each division or compartment includes a food item, e.g., a meat product, a vegetable, and a dessert. All of the food items are heated together in the microwave oven in their respective compartments. Other conventional food products require pre-mixing of ingredients or mixing ingredients following heating in a microwave (e.g., pasta and sauce).

Conventional food items and ingredients for food items prepared in a microwave oven, however, can be improved. Conventional food item are typically prepared with limited ingredients or additives, but do not enhance other aspects of the food item or do so to a limited degree. For example, while some microwaved food items are prepared using susceptor surfaces, the food items do not provide have the appearance and aromas that are typically associated with a grilled or barbequed food item.

A need, therefore, exists for ingredients that are suitable for microwave food items, particularly grilled food items, to provide flavorings and aromas, such as grilled or barbequed flavorings and aromas, to a grilled food product prepared in a microwave oven.

### SUMMARY OF THE INVENTION

The present invention provides an ingredient, a combination food item and ingredient, and a method of preparing an ingredient that provides a grilled or other desired taste to food items prepared in a microwave oven.

In accordance with the present invention is an ingredient for application to a food item prepared in a microwave oven. The ingredient includes a gelatinous base and one or more additives mixed with said gelatinous base to form a mixture. When heated, the mixture may melt and release steam with one or more additives onto the food item.

Also in accordance with the present invention is a grilled food product and ingredient combination for preparation in a microwave oven. The combination includes a food item and a gelatinous ingredient. The gelatinous ingredient includes a gelatinous base and one or more additives that are mixed together. Heating the ingredient releases steam with the one or more additives, which are applied to the food item.

In further accordance with the present invention is a method of preparing a gelatinous ingredient that is heated to produce steam. One or more additives in the gelatinous ingredient are included in the steam and applied to a food item. The gelatinous ingredient is prepared by providing a gelatinous base and one or more additives, mixing the gelatinous base and the one or more additives together to form a first mixture, mixing the first mixture and water in a ratio of about 1:4 to about 1:7 to form a second mixture, heating the second mixture, and cooling the second mixture to form the gelatinous ingredient.

The second mixture can be heated to about 160 degrees F. to about 180 degrees F., preferably about 170 degrees F. The second mixture can be cooled to about 90 degrees F. to about 112 degrees F., preferably about 102 degrees F., to form the gelatinous product. The gelatinous product can then be formed into various shapes.

The gelatinous base can be an agar, a corn syrup solid, or a combination thereof. The additives can include a mono- or di-glycerides, a cellulose powder, a caramel color, a soybean oil, and a flavoring for the food item. Flavorings include a charcoal or grill flavoring, a beef flavoring, a barbeque flavoring, and a lemon flavoring. In one embodiment, the ingredient includes about 24.1% agar, about 34.7% corn syrup solid, about 13.5% grill flavor, about 9.6% mono- or di-glycerides, about 4.8% cellulose powder, about 4.8% caramel color, about 3.9% soybean oil, about 3.9% char flavor, and about 0.7% beef flavor based on a weight of the ingredient.

### BRIEF DESCRIPTION OF THE DRAWINGS

Referring now to the drawings in which like reference numbers represent corresponding parts throughout:

FIGS. 1A-C are respective top, side, and bottom views of an open microwaveable housing according to the present invention;

FIG. 2A illustrates a gelatinous ingredient; according to the present invention, and FIG. 2B is a top view of a housing with a gelatinous ingredient;

FIG. 3 is a flow diagram illustrating a method of making a gelatinous ingredient according to one embodiment of the present invention;

FIGS. 4A-B are respective top and perspective views of the housing shown in FIGS. 2A-B and different grill surfaces placed above the ingredient for supporting a food item thereon;

FIGS. 5A-B are perspective and top views of a closed or sealed microwave cooking grill product; and

FIG. 6 is a flow diagram showing a method of utilizing the microwave cooking apparatus or product to prepare a microwaved food item according to the present invention.

### DETAILED DESCRIPTION OF PREFERRED EMBODIMENTS

In the following description, reference is made to the accompanying drawings which form a part hereof, and which show by way of illustration specific embodiments in which the invention may be practiced. It is to be understood that other embodiments may be utilized as structural changes may be made without departing from the scope of the present invention.

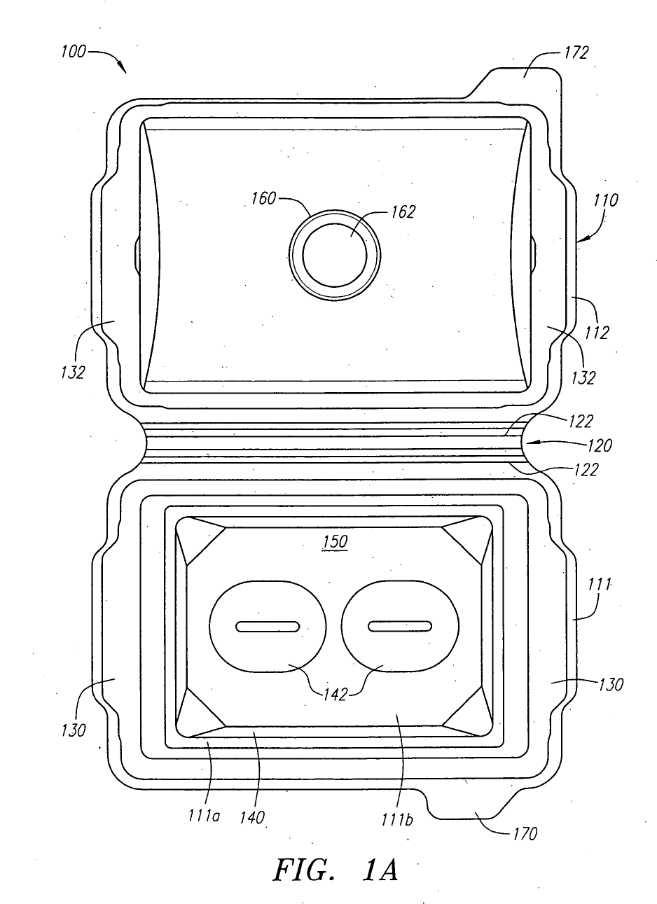

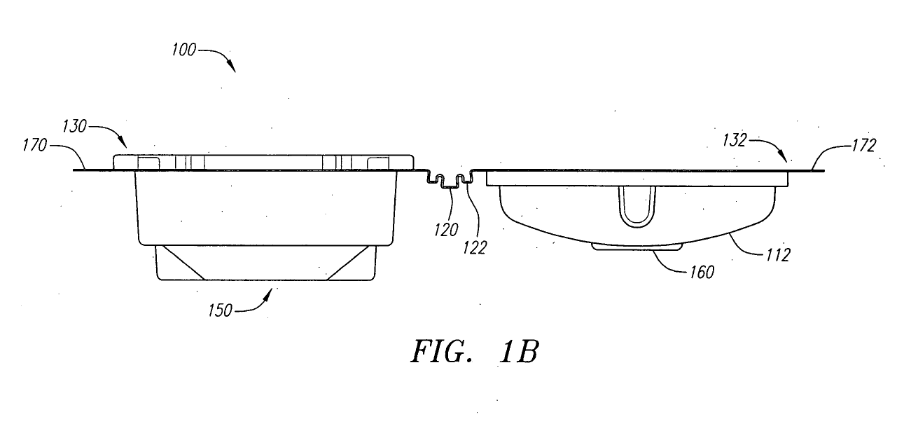

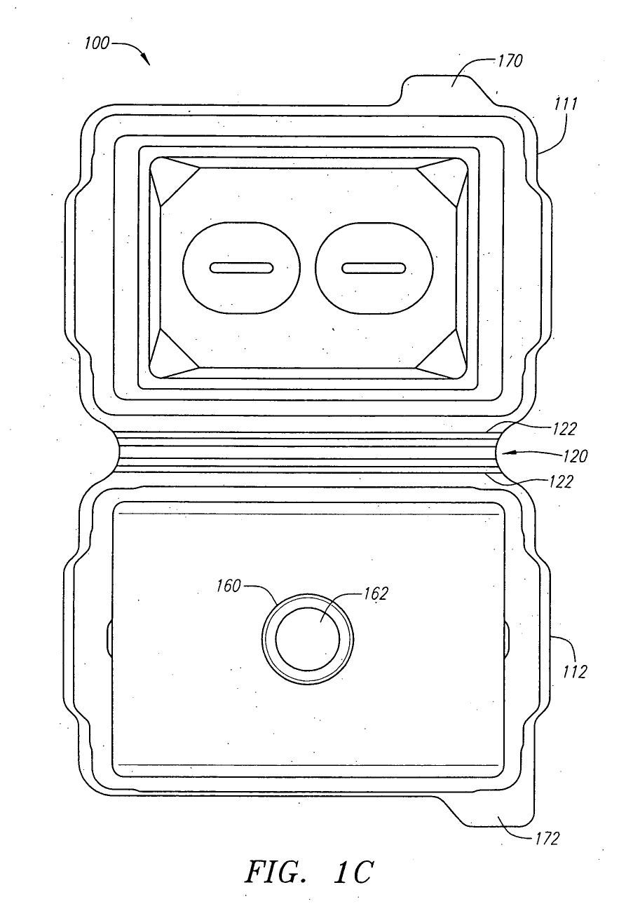

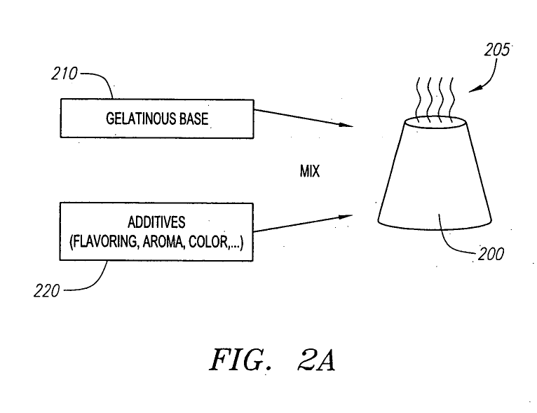

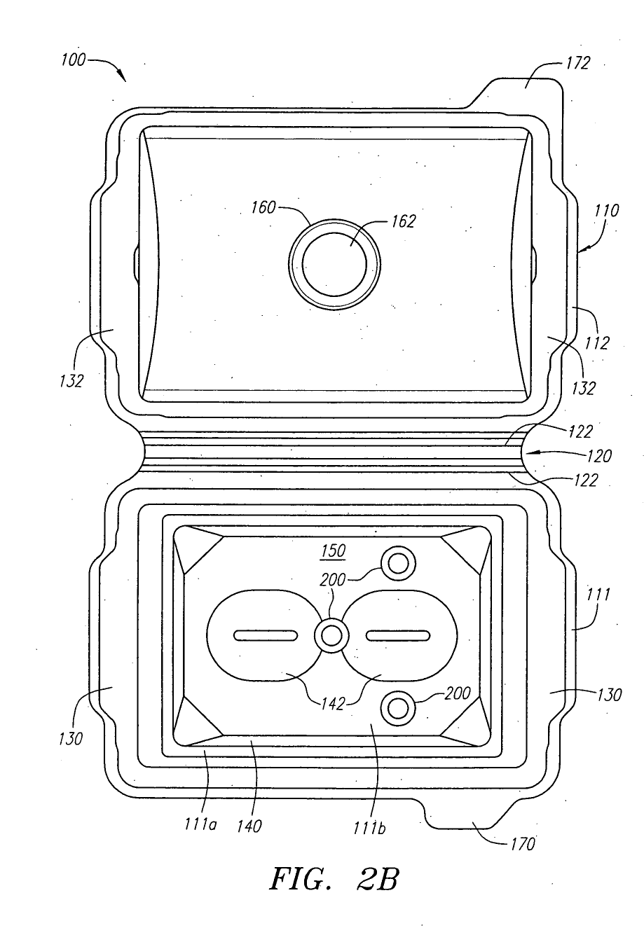

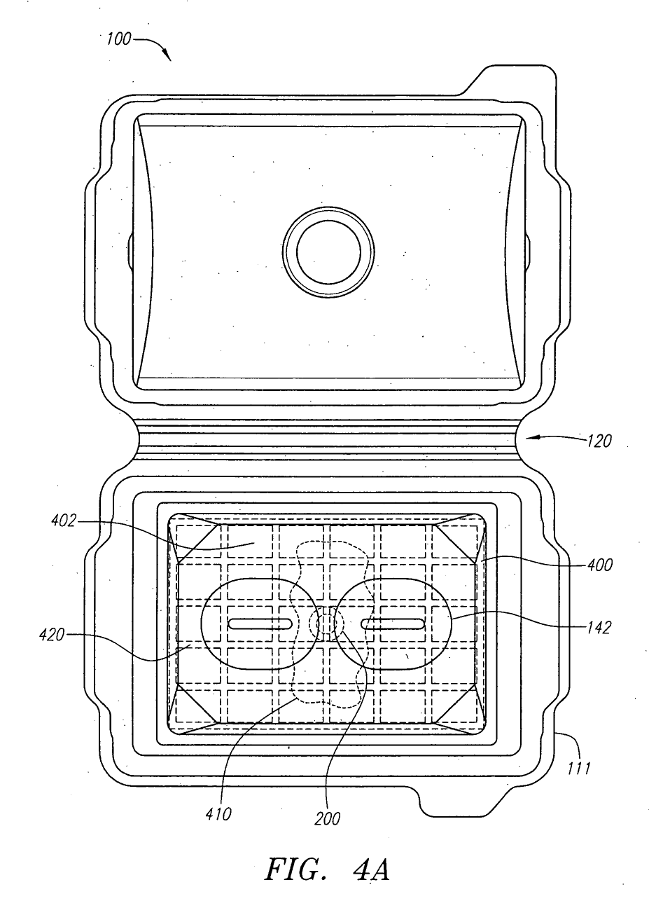

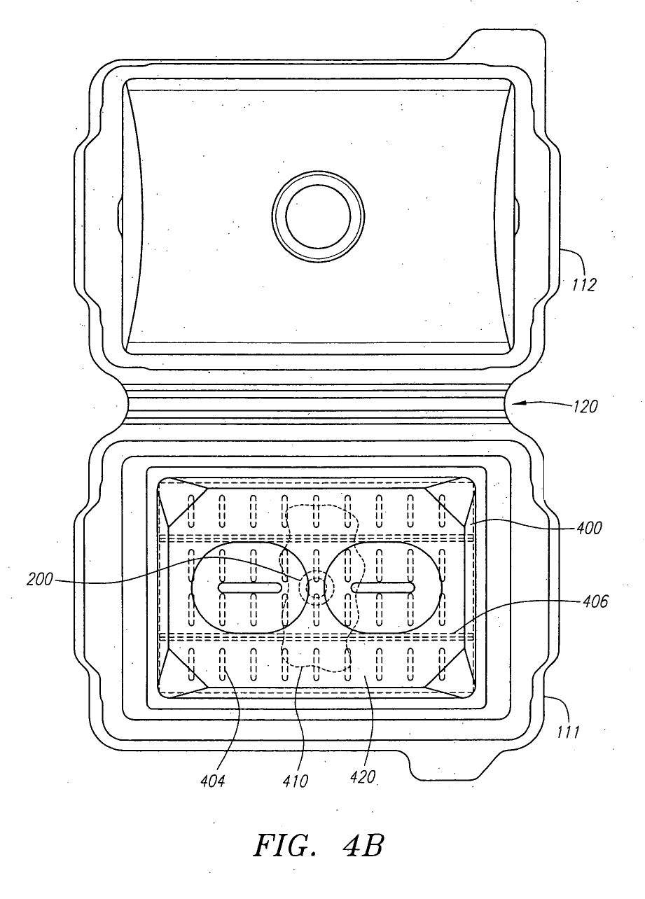

Referring to FIGS. 1A-C, one embodiment of the present invention provides a microwave grilling apparatus 100. The apparatus 100 includes a microwaveable housing 110, an ingredient or additive, and a grill surface. The ingredient or additive is removed from the apparatus shown in FIGS. 1A-C, but is shown in FIGS. 2A-B). The grill or grill surface is also removed from the apparatus shown in FIGS. 1A-C, but is shown in FIGS. 4A-B. Referring to FIG. 2B, the ingredient 200 is placed in a lower section of the housing 110. The ingredient 200 can, for example, add a color, a flavoring, or an aroma to the food item. Referring to FIGS. 4A-B, the grill 400 is placed above the ingredient 200 and supports the food item 410. Steam 202 from the heated ingredient 200 is applied to or diffused onto the food item 410. An additive, such as a flavoring, a coloring or an aroma can be applied to the grilled food item 410. Excess steam or moisture from the heated food item 410 and ingredient 200 can be released from the housing 110 via a vent 160 to reduce the moisture content or sogginess of the grilled food item 410.

With the previously described arrangement, the grill 400 separates the ingredient 200 from the food item 410, while the food item 410, the grill 400 and the ingredient 200 are contained within the housing 110. Heating the microwave housing 110 also heats the ingredient 200 and the food item 410. The ingredient 200 partially or completely liquefies and/or melts from a solid, gelatinous, or semi-solid state so that steam 202 is applied or diffused onto the food item 410 through apertures in the grill 400, thereby enhancing the flavor, aroma, texture, and appearance of the food item 410.

As will be understood from reading this specification, the present microwaveable grilling apparatus 100 can be used to heat and prepare various types of food items 410 including, but not limited to, fish, beef, poultry, pork, and meat-substitute products such as vegetable and soybean products. Persons of ordinary skill in the art will also recognize that various food ingredients 200 with different additives can be used to provide different enhancements to a grilled food item 410.

The present invention improves upon conventional microwave containers and products since it provides a microwaved food item having a grilled appearance while enhancing the grilled food item with selected ingredients that add flavorings, aromas and colorings to the food item, while controlling the moisture content of the food item. Having generally described the microwave cooking apparatus of the present invention and the manner of using the apparatus, this specification describes the individual apparatus components, a gelatinous ingredient that can be used with the apparatus, a method of preparing a gelatinous ingredient, a microwaveable grill product.

Referring again to FIGS. 1A-C, in one embodiment, the microwaveable housing 110 includes a lower housing section 111, an upper housing section 112, and a connector 120 (if necessary). Exemplary microwaveable housing 110 materials include polypropylene, polyester, polystyrene, and other suitable microwaveable materials.

The housing 110 can be configured so that the upper housing section 111 is placed directly onto the lower housing section 112 with, e.g., a snap and lock configuration. Thus, a connector 120 may not be needed depending on the particular housing configuration. Alternatively, as shown in FIGS. 1A-C, a connector 120 secures the lower and upper housing sections 111 and 112 together. While either configuration can be used, the embodiment having housing sections 111 and 112 joined by the connector 120 is described and illustrated in this specification.

FIGS. 1A-C show a generally rectangular shaped housing 110. Persons of ordinary skill in the art, however, will appreciate that different housing 110 shapes and sizes can be utilized. For example, the housing 110 can have square, circular, elliptical, and other shapes by changing the shape of the housing 110, the grill 400 and other related components. For purposes of explanation and illustration, however, this specification refers to and illustrates a housing 110 having a generally rectangular shape.

Moreover, the upper and lower housing sections 111 and 112 shown in FIGS. 1A-C are generally divided into lower and upper housing “halves” or sections (although the lower housing section 111 is slightly larger than the top housing section 112). Again, the invention is not so limited. Rather, the upper and lower housings 111 and 112 can be appropriately dimensioned and proportioned based on, for example, the dimensions of the grill 400, the food item 410, and the ingredient 200.

Additionally, FIGS. 1A-C illustrate the optional connector 120 having flexible ridges 122 that join the lower and upper housing sections 111 and 112. Indeed, other connectors 120 can also be used, such as a flexible non-webbing connector or a microwaveable hinge about which one of the housing sections 111 and 112 can be rotated. Thus, the connector 120 shown in FIGS. 1A-C is merely illustrative of different possible connector configurations.

The housing sections 111 and 112 can also be closed or sealed using various attachment or locking, or sealing configurations. For example, FIGS. 1A-C illustrate a “snap and lock” configuration in which locking ridges or sections 130 of the lower housing section 111 are inserted within corresponding receiving sections or indentations 132 formed in the upper housing section 112. Other configurations can also be used, and the locking and receiving sections 130 and 132 are merely illustrative examples of possible configurations.

The lower housing section 111 also includes one or more support members for the grill 400. One exemplary support member is a ridge or lip 140 that extends from one or more interior surfaces 111a of the lower housing section 111. For example, FIGS. 1A-C show a support lip 142 protruding from and extending around the interior surface 111a of the lower housing 111. The grill 400 is placed on the support lip 142.

Other lip configurations can also be utilized, e.g., one or more support sections can extend from different interior surfaces to support the grill 400. Further, one or more base support members 142 can support the grill 400, as shown in FIGS. 1A-C. The base support members 142 extend up from the bottom 111b of the lower housing section 111 to support the grill 400. In yet a further alternative embodiment, the support member can be a groove, indentation or impression that is shaped and dimensioned to receive a corresponding edge of the grill 400 therein. A combination of different lateral and vertical support members can also be utilized.

The lower housing section 111 can also include a reservoir or storage area 150 for storing and retaining the ingredient 200. In the embodiment shown in FIGS. 1A-C, the reservoir 150 is defined by the lip 140 extending around the interior of the lower housing section 111. The reservoir 150 can hold a liquid, a sauce, an oil, or fat that drips down from the food item 410 through the grill 400. Thus, the reservoir 150 retains the “melted” portion of the ingredient 200.

The upper housing section 112 includes a vent 160 with one or more vent apertures 162. The size of the vent aperture 162 can be increased or decreased to change the amount of steam from the cooked food item 410 and the ingredient 200 released from the housing 110. For example, different quantities of steam may be released from the food item 410 depending on the type of food item 410 prepared or the oil or moisture content of the food item 410.

Further, the steam 205 from the heated ingredient 200 exists through the aperture 162 and can provide a grilling impression to a consumer. For example, if the ingredient 200 is a charcoal ingredient, steam 205 released from the heated ingredient 200 can have a “smoke” color so that the food item 410 appears to be cooked on a barbeque grill as the smoke rises through the housing 110 and out through the aperture 162. In this particular embodiment, smoke that is released through the aperture 162 and inside the microwave oven can be vented from the microwave oven with a fan so that the smoke does not accumulate in the microwave.

Persons of ordinary skill in the art will recognize that various vent 160 configurations can be used. For example, FIGS. 1A-C illustrate a vent 160 in the form of a single circular aperture 162 defined within the upper housing section 112. Alternatively, a separate vent can be attached to the upper housing section 112 and be in communication with one or more apertures formed in the upper housing section 112. As a further alternative to the single aperture vent shown, the vent 160 can be an adjustable vent, such as a rotatable or slide vent, with a one or more apertures. In yet a further alternative embodiment, a vent could be located on a side or end of the housing section 112. Thus, the size, location and number of vent apertures can be adjusted as needed to change the amount of steam that is retained in the housing 110 which, in turn, changes the moisture content in the cooked food item 410.

Further, the housing sections 111 and 112 can include extension tabs or lips to enable a user to open and close the container. For example, the lower housing 111 can include a first tab 170, and the upper housing 112 can include a second tab 172. The tabs 170 and 172 are non-overlapping or offset so that a user can apply pressure to or pull one of the tabs 170 or 172 to separate the lower and upper housings 111 and 112.

Turning now to FIGS. 2A-B, in one embodiment, the ingredient 200 is gelatinous ingredient that includes a gelatinous base 210 and one or more additives 220. The ingredient 200 can have various shapes and additives 220 depending on the food item 410 to be prepared. For example, as previously discussed, the ingredient 200 can be a gelatinous sauce or pad that produces steam 205 when heated. The steam 205 is applied or diffused onto the food item 410 to add an additive 220, such as a flavoring, a coloring, an aroma, or a texture to the food item 410. For example, the ingredient 200 can release steam 205 with charcoal, beef, and barbeque flavorings 220 for beef and chicken food items 410. The ingredient 200 can also release steam 205 with a lemon flavoring 220 for fish food, items 410. The ingredient 200 can also release steam 205 that adds various colorings 220 to the grilled food item 410, such as a dark coloring, so that the food item 410 can have a color that is consistent with grilling. For example, the ingredient 200 can release steam 205 with dark, black, brown or caramel colorings 220 for the food item 410. The steam 205 can also include an aroma, such as grilling or charcoal aromas.

In one embodiment, the gelatinous sauce 200 includes a gelatinous base 210 and one or more additives 220. The base 210 and the additives 220 are mixed together to form a mixture. The mixture is heated in the microwave oven and can partially or completely melt into a liquid. The heated mixture releases steam 205 that includes one or more additives 225. The steam 205 and the additives 220 are applied to the food item 410.

The gelatinous base 210 may include an agar, such as an agar gum, a corn syrup solid, such as a 25 Dextrose Equivalent (DE) corn syrup solid, a combination of an agar and a corn syrup, or other substances that have a gelatinous or gel-like structure and can release steam 205 when heated. The additives 220 that are mixed with the gelatinous base 210 can include, for example, mono- and di-glycerides, a cellulose powder, a caramel color, a soybean oil, a flavoring such as a char flavoring, a beef flavoring, a barbeque flavoring, and/or a lemon flavoring.

Various mono- and di-glycerides can be utilized, e.g., mono- and di-glycerides available from Danisco A/S, Copenhagen, Denmark. Exemplary grill flavorings include Flavor 7072, available from Red Arrow International, LLC, Manitowc, Wis. Exemplary char flavorings include Gen 1462, available from ConAgra Food Ingredients Company, Cranbury, N.J. Exemplary beef flavorings include Gen 2365, available from ConAgra Food Ingredients Company. Exemplary barbeque flavorings include 3-1108 Barbeque Seasoning, available from ConAgra Food Ingredients Company, Carol Stream, Ill. Exemplary lemon flavorings include 3-1363 Lemon Pepper, available from ConAgra Food Ingredients Company, Carol Stream, Ill. Various additives from other sources may also be utilized as needed.

In one embodiment, as previously discussed, the ingredient 200 provides a grilled or charcoaled flavoring to the food item 410. The steam 205 released from the heated ingredient 200 appears as “smoke” that rises through the housing 400 and out through the aperture 162, thus providing the impression that the food item 410 is being cooked over an actual grill or open flame.

Components of one embodiment of an ingredient 200 are provided below. The exemplary 300 gram sample of the ingredient 200 provides grill or charcoal flavorings and aromas to a grilled food item:

| Ingredient | Grams | Weight % |
|---|---|---|
| Corn Syrup Solids 25 DE | 104.145 | 34.715 |
| Agar Gum | 72.3240 | 24.108 |
| Grill Flavor 7072 | 40.5000 | 13.500 |
| Mono-/Di-Glycerides | 28.9290 | 9.6430 |
| Cellulose Powder | 14.4738 | 4.8246 |
| Caramel Color BC 420 | 14.4600 | 4.8200 |
| Soybean Oil | 11.6000 | 3.8570 |
| Char Flavor Gen 1462 | 11.6000 | 3.8570 |
| Bloody Beef Flavor Gen 2365 | 2.02620 | 0.6754 |
| TOTAL | 300.0 | 100% |

Other types and quantities of ingredients can be utilized to provide different flavorings, aromas and colorings.

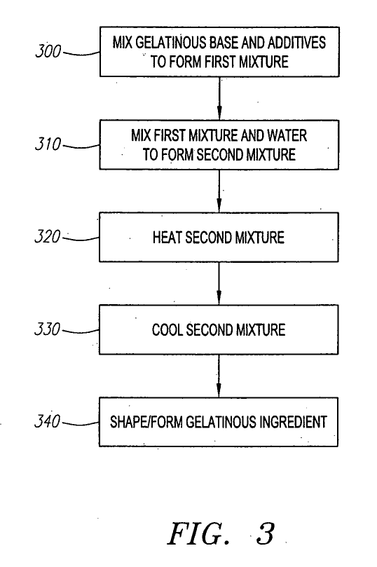

Referring to FIG. 3, although different ingredients 200 may be prepared using different methods, following is a description of a method for preparing the previously described “charcoal” ingredient that releases “smoke” when heated in a microwave oven according to one embodiment of the present invention. In step 300, the gelatinous base 210 and one or more additives 220 are mixed together to form a first mixture. In step 310, the first mixture is then mixed with water to form a second mixture. In one embodiment, the ratio of the first mixture to water is about 51.85 grams of mixture to about 250 grams of water or about a ratio of about 1:5 mixture to water by weight. Other mixture to water ratios can also be utilized, such as a ratio of about 1:4 to about 1:7, preferably a ratio of about 1:5. In step 320, the second mixture is heated. For example, the second mixture can be heated to about 160 degrees F. to about 180 degrees F. for, preferably to about 170 degrees F. In step 330, the second mixture is cooled to form the gelatinous ingredient 200. For example, the second mixture can be cooled from one of the heating temperatures to about 90 degrees F. to about 112 degrees F., preferably to about 102 degrees F.

In step 340, the gelatinous ingredient 200 may be formed into different shapes and sizes during or after cooling. For example, as shown in FIGS. 2A-B, the gelatinous ingredient 200 can have a cylindrical shape. Other possible shapes include a cube, a rectangular shape, or other shapes depending on the design of the microwaveable housing.

Referring to FIGS. 4A-B, the grill surface 400 is located in the lower housing section 111 and retained or supported by support members 140 and 142. In use, steam 205 from the heated ingredient 200 rises around or up through the grill apertures 402 and is applied to the bottom or sides of the food item 410. The steam 205 can also be diffused within the housing 110 and applied to one or more surfaces of the food item 410, such as side and top surfaces.

FIG. 4A shows one exemplary grill surface 400 that includes a checkerboard-type design of apertures 402. FIG. 4B illustrates an alternative grill configuration 400 that includes narrower slot apertures 404 and ridges 406 to elevate and support the food item 410. The grill 400 can be formed with different designs and numbers of grilling surfaces and apertures depending on the type, size, number and ingredients of the food item being prepared. Although various grill 400 configurations can be used, this specification refers to the grill shown in FIG. 4A for purposes of explanation and illustration.

The grill apertures 402 serve two purposes. First, the apertures 402 permit liquid, oil or fat or other drippings from the heated food item 410 to be drained down into the bottom of the lower housing section 111 or into the reservoir 150. Second, steam 205 from the heated ingredient 200 rises up through the apertures 402 and onto the food item 410.

Preferably, the grill 400 is coated or laminated with a susceptor material 420, such as a metallic susceptor material. The susceptor material 420 focuses energy from the microwave oven and reaches a sufficiently high temperature to burn a grill pattern onto the food item 410. Further, heated susceptor material 420 can make the food item 410 sizzle.

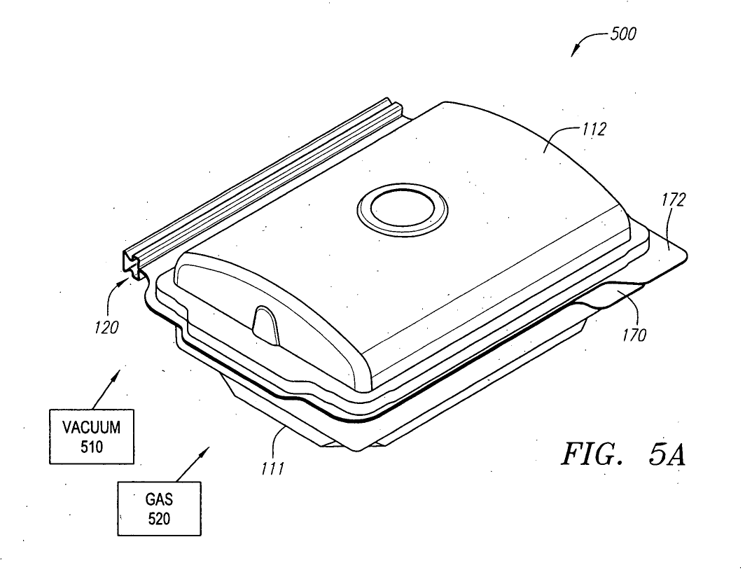

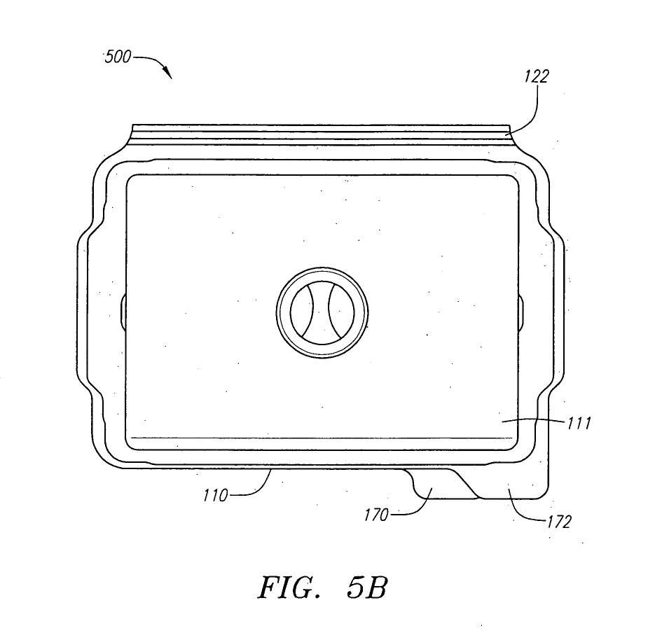

FIGS. 5A-B illustrate a microwaveable food product with the grill 400 placed on the support member 140 and over the food ingredient 200. The product 500 includes the gelatinous food ingredient 200, the grill 400, and the food item 410. The ingredient 200 is placed within the reservoir 150 or the lower housing section 111, and the grill 400 is installed above the ingredient 200. The food item 410 is placed on top of the grill 400. The upper and lower housing sections 111 and 112 are sealed to prevent external elements and air from contacting the food item 410 or the gelatinous ingredient 200, thereby protecting against potential contamination or product staling.

The interior of the package 500 can also be evacuated of air with a vacuum system 510 and maintained by a film barrier or other suitable seal (not shown). Alternatively, an inert gas or preservative 520, such as nitrogen and/or carbon dioxide, can be pumped inside the sealed housing 500 to reduce decay, oxidation and spoilage of the food product and ingredients. The gas or preservative can be retained by a film barrier or other suitable seal (not shown) over the product. The packaged microwave food product 500 can then be stored until the product is purchased and/or ready to be prepared. At that time, the film barrier can be removed from the packaged product, and the product can be inserted into the microwave and heated. The cooked food item 410 can be removed, and the housing 100 with the remaining ingredient 200 and the grill 400 can then be discarded.

Having described the microwave grill apparatus 100, an ingredient, 200, and a packaged product 500 including the apparatus components, following is a description of the steps performed for preparing a microwaved food product.

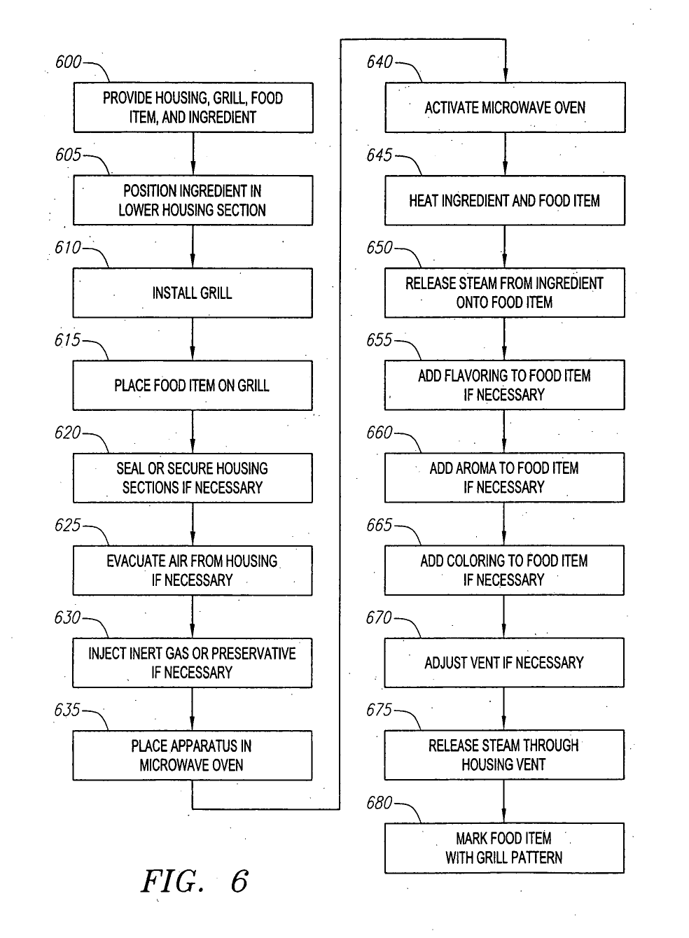

Referring to FIG. 6, in step 600, a microwaveable housing, a grill, a food item, and an ingredient for the food item are provided. The grill, the ingredient, and the food item are contained within the microwaveable housing. In step 605, the ingredient is positioned in a reservoir or a lower housing section of the housing.

In step 610, the grill is installed over the ingredient and secured or supported by support members in the lower housing section. In step 615, the food item is arranged or positioned on the grill. As a result, the ingredient is positioned below the food item. In step 620, if necessary, the housing sections are sealed or secured together.

In step 625, if necessary, air is evacuated from the housing interior. An inert gas or preservative may also be injected into the housing to reduce decay and spoiling of the food item and ingredient. The gas or preservative can be retained by a film barrier that is sealed over the product. These steps are performed in connection with the packaged product shown in FIG. 5.

In step 630, the apparatus or product is placed inside the microwave oven. In step 635, the microwave oven is activated to heat the microwaveable housing and the grill, food item, and ingredient inside the housing.

In step 640, the ingredient is sufficiently heated and/or melted or liquefied by the microwave oven energy. As a result, in step 645, steam released from the heated ingredient rises around or through apertures of the grill and onto the food item. The steam or ingredient can also be diffused onto one or more surfaces of the food item to, for example, add a flavoring (step 650), add an aroma (step 655), and add a coloring (step 660) to the grilled food item.

In step 665, if necessary, a vent in the upper housing section is adjusted and, in step 670, steam is released from the housing through the vent aperture. As a result, the water content of the grilled food product is adjusted to prevent the product form being too soggy or moist. In step 675, an underside of the food item is marked with a pattern of the grilling surface by metal susceptor grill surfaces.

Persons of ordinary skill in the art will appreciate that the exact method steps previously described may not occur in the exact recited order. For example, the venting and grilling/marking steps can occur at different stages depending on the amount of heat and steam generated.

Having described the microwaveable cooking grill apparatus, a gelatinous ingredient for application to a grilled food item prepared in the apparatus, a packaged microwave product, and methods of preparing the gelatinous ingredient and preparing a food item with the ingredient and apparatus, persons of ordinary skill in the art will recognize that the above apparatus and methods can be utilized with various food items, ingredients, housings, grills, and vents. As a result, different heating times and preparation temperatures can be utilized as needed. Further, although the specification describes a gelatinous ingredient that is heated so that steam is applied to a food item above, the grill arrangement can be modified in different ways. For example, a gelatinous ingredient can be placed on top of a food item, which is placed on or between susceptor or grilling surfaces. Thus, when the components are heated in a microwave oven, the ingredient can melt or liquefy over the grilled food item.

Although references have been made in the foregoing description to various embodiments, persons of ordinary skill in the art of microwave products and food items and related systems will recognize that insubstantial modifications, alterations, and substitutions can be made to the described embodiments without departing from the invention as claimed in the accompanying claims, particularly considering that the apparatus, product, and method of the present invention can be used with different food items and ingredients.

What is claimed:

1-35. (canceled)

36. A method of preparing a gelatinous ingredient that is heated to produce steam, the steam including one or more additives that are applied to a food item, the method comprising:
providing a gelatinous base and one or more additives;
mixing the gelatinous base and the one or more additives together to form a first mixture;
mixing the first mixture and water in a ratio of about 1:4 to about 1:7 to form a second mixture, the ratio being based on weights of the first mixture and the water;
heating the second mixture; and
cooling the second mixture to form the gelatinous ingredient.

37. The method of claim 36, heating the second mixture further comprising heating the second mixture to about 160 degrees F. to about 180 degrees F.

38. The method of claim 37, heating the second mixture further comprising heating the second mixture to about 170 degrees F.

39. The method of claim 36, cooling the second mixture further comprising cooling the second mixture to about 90 degrees F. to about 112 degrees F.

40. The method of claim 39, cooling the second mixture further comprising cooling the second mixture to about 102 degrees F.

41. The method of claim 36, further comprising, after cooling, shaping the gelatinous ingredient.

42. The method of claim 36, providing the gelatinous base further comprising providing an agar.

43. The method of claim 36, providing the gelatinous base further comprising providing a corn syrup solid.

44. The method of claim 36, providing the gelatinous base further comprising providing an agar and a corn syrup solid.

45. The method of claim 36, providing one or more additives further comprising providing a mono- or di-glyceride.

46. The method of claim 36, providing one or more additives further comprising providing a cellulose powder.

47. The method of claim 36, providing one or more additives further comprising providing a caramel color.

48. The method of claim 36, providing one or more additives further comprising providing a soybean oil.

49. The method of claim 36, providing one or more additives further comprising providing a flavoring for the food item.

50. The method of claim 49, providing the flavoring further comprising providing a charcoal flavoring.

51. The method of claim 49, providing the flavoring further comprising providing a beef flavoring.

52. The method of claim 49, providing the flavoring further comprising providing a barbeque flavoring.

53. The method of claim 49, providing the flavoring further comprising providing a lemon flavoring.

54. The method of claim 36, mixing the gelatinous base and one or more additives together further comprising:
mixing a gelatinous base having an agar and a corn syrup solid and one or additives including a grill flavor, mono- or di-glycerides, a cellulose powder, a caramel color, a soybean oil, a char flavor, and a beef flavor.

55. The method of claim 54, mixing further comprising
mixing about 24.1% of said agar, about 34.7% of said corn syrup solid, about 13.5% of said grill flavor, about 9.6% of said mono- or di-glyceride, about 4.8% of said cellulose powder, about 4.8% of said caramel color, about 3.9% of said soybean oil, about 3.9% of said char flavor, and about 0.7% of said beef flavor, the percentages being based on a weight of the gelatinous ingredient.
